(19) United States
(12) Patent Application Publication
(10) Pub. No.: US 2014/0240307 A1
(43) Pub. Date: Aug. 28, 2014

(54) LEVEL SHIFT CIRCUIT AND DRIVING METHOD THEREOF

(71) Applicant: AU OPTRONICS CORP., Hsin-Chu (TW)

(72) Inventors: Yun-Chi Chen, Hsin-Chu (TW); Yueh-Han Li, Hsin-Chu (TW); Huang-Ti Lin, Hsin-Chu (TW); Ming-Sheng Lai, Hsin-Chu (TW)

(73) Assignee: AU Optronics Corp., Hsin-Chu (TW)

(21) Appl. No.: 13/863,390

(22) Filed: Apr. 16, 2013

(30) Foreign Application Priority Data
Feb. 22, 2013 (TW) 102106291

(51) Int. Cl. G09G 5/12

(52) U.S. Cl. CPC G09G 5/12
USPC 345/213; 327/333; 327/108

(57) ABSTRACT

A level shift circuit includes an input end, a decoding circuit, a control circuit, and a plurality of output circuits. The input end is configured to receive a coded signal string including a starting code, a setting code, a clock standard signal and an ending code. The decoding circuit is coupled to the input end for decoding the coded signal string and outputting the starting code, the setting code, the clock standard signal and the ending code respectively. The control circuit is coupled to the decoding circuit for controlling logic levels of a plurality of logic driving signals according to the setting code and the clock standard signal after receiving the starting code, and stopping changing the logic driving signals after receiving the ending code. The plurality of output circuits are coupled to the control circuit for outputting a plurality of clock signals according to the corresponding logic driving circuit.

### BACKGROUND OF THE INVENTION

1. Field of the Invention

The present invention relates to a level shift circuit, and more particularly, to a level shift circuit capable of simplifying a signal transmission interface.

2. Description of the Prior Art

Please refer to FIG. 1 and FIG. 2. FIG. 1 is a diagram showing a display device 100 of the prior art. FIG. 2 is a diagram showing a level shift circuit 110 of the prior art. The level shift circuit 110 is configured to generate a plurality of clock signals according to a driving signal transmitted from a timing controller 130 of the display device 100. A gate driving circuit 140 of the display device 100 then sequentially generates a plurality of scanning signals according to the clock signals of the level shift circuit 110 for further driving a display module 120. As shown in FIG. 2, the level shift circuit 110 of the prior art comprises a plurality of input end Pi (such as 8 input ends) and a plurality of setting ends Ps (such as 4 setting ends). The input ends Pi are coupled to the timing controller 130 for respectively receiving driving signals transmitted from the timing controller 130, such as a starting signal, a clock signal, an ending signals, etc. The setting ends Ps are configured to receive setting signals in order to control the level shift circuit 110 to generate a plurality of different clock signals, such as high-frequency clock signals and low-frequency clock signals, according to the received driving signals.

However, a signal transmission interface 102 between the level shift circuit 110 and the timing controller 130 of the prior art requires at least 8 signal lines arranged for respectively transmitting different driving signals. Moreover, the level shift circuit 110 of the prior art further requires 4 more signal lines for receiving the setting signals. Therefore, the signal lines of the level shift circuit of the prior art occupy too much space on circuit boards, so as to increase difficulties and complexity for circuit layout design.

### SUMMARY OF THE INVENTION

The present invention provides a level shift circuit comprising an input end, a decoding circuit, a control circuit, and a plurality of output circuits. The input end is configured to receive a coded signal string comprising a starting code, a setting code, a clock standard signal, and an ending code. The decoding circuit is coupled to the input end for decoding the coded signal string and outputting the starting code, the setting code, the clock standard signal, and the ending code respectively. The control circuit is coupled to the decoding circuit for controlling logic levels of a plurality of logic driving signals according to the setting code and the clock standard signal after receiving the starting code, and stopping changing the logic levels of the logic driving signals after receiving the ending code. The plurality of output circuits are coupled to the control circuit for outputting a plurality of clock signals according to the corresponding logic driving signals.

The present invention further provides a display driving system comprising a timing controller, a level shift circuit, and a gate driving circuit. The timing controller is configured to generate a coded signal string according to a timing signal. The coded signal string comprises a starting code, a setting code, a clock standard signal, and an ending code. The level shift circuit comprises an input end, a decoding circuit, a control circuit, and a plurality of output circuits. The input end is configured to receive the coded signal string. The decoding circuit is coupled to the input end for decoding the coded signal string and outputting the starting code, the setting code, the clock standard signal, and the ending code respectively. The control circuit is coupled to the decoding circuit for controlling logic levels of a plurality of logic driving signals according to the setting code and the clock standard signal after receiving the starting code, and stopping changing the logic levels of the logic driving signals after receiving the ending code. The plurality of output circuits are coupled to the control circuit for outputting a plurality of clock signals according to the corresponding logic driving signals. The gate driving circuit is configured to sequentially generate a plurality of scanning signals according to the plurality of clock signals.

The present invention further provides a driving method of a level shift circuit. The method comprises providing a level shift circuit comprising an input end, a decoding circuit, a control circuit, and a plurality of output circuits; the input end receiving a coded signal string comprising a starting code, a setting code, a clock standard signal, and an ending code; the decoding circuit decoding the coded signal string for outputting the starting code, the setting code, the clock standard signal, and the ending code to the control circuit respectively; the control circuit controlling logic levels of a plurality of logic driving signals according to the setting code and the clock standard signal after receiving the starting code, and stopping changing the logic levels of the plurality of logic driving signals after receiving the ending code; and the plurality of output circuits outputting a plurality of clock signals according to the corresponding logic driving signals.

The present invention further provides a display device comprising a display module, a timing controller, a level shift circuit, and a gate driving circuit. The display module is configured to display images according to image data. The timing controller is configured to generate a coded signal string according to a timing signal. The coded signal string comprises a starting code, a setting code, a clock standard signal, and an ending code. The level shift circuit comprises an input end, a decoding circuit, a control circuit, and a plurality of output circuits. The input end is configured to receive the coded signal string. The decoding circuit is coupled to the input end for decoding the coded signal string and outputting the starting code, the setting code, the clock standard signal, and the ending code respectively. The control circuit is coupled to the decoding circuit for controlling logic levels of a plurality of logic driving signals according to the setting code and the clock standard signal after receiving the starting code, and stopping changing the logic levels of the logic driving signals after receiving the ending code. The plurality of output circuits are coupled to the control circuit for outputting a plurality of clock signals according to the corresponding logic driving signals. The gate driving circuit is coupled between the level shift circuit and the display module for sequentially generating a plurality of scanning signals according to the plurality of clock signals and outputting the plurality of scanning signals to the display module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a display device of the prior art.

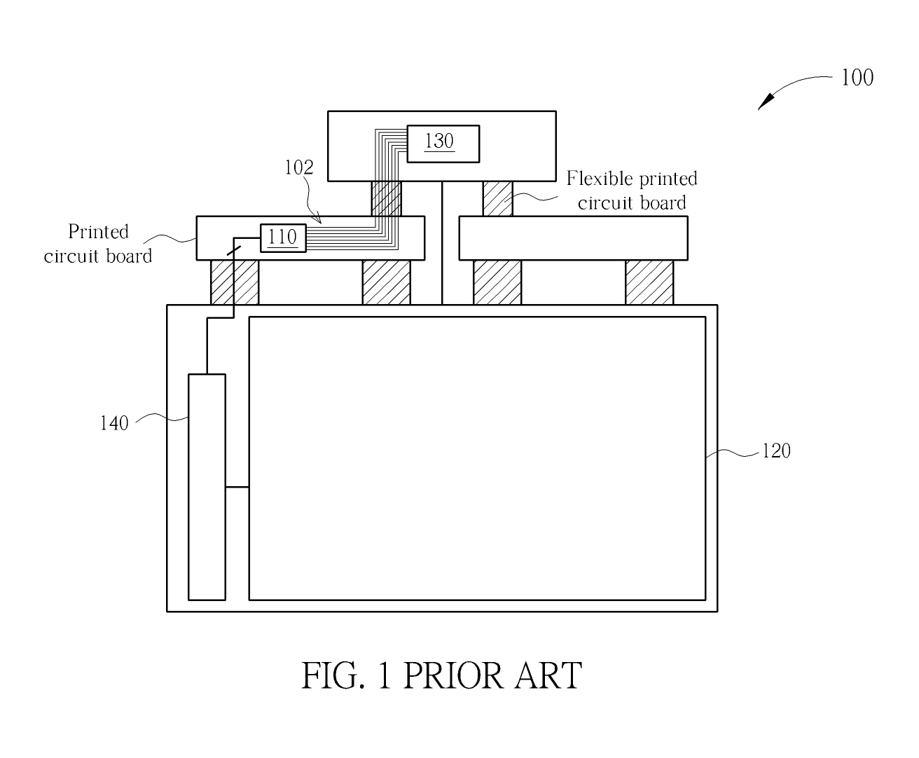

FIG. 2 is a diagram showing a level shift circuit of the prior art.

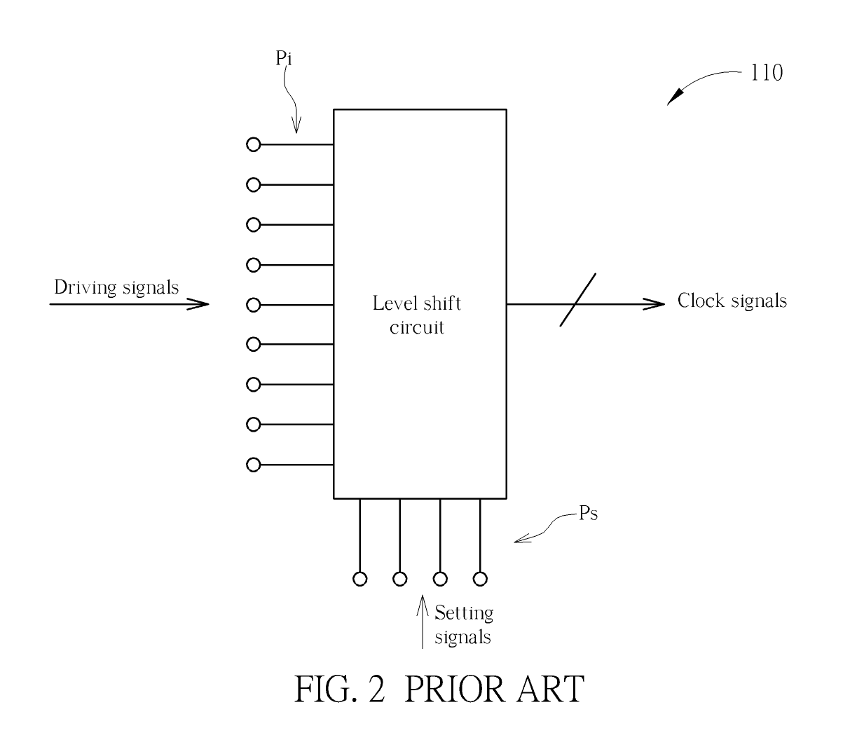

FIG. 3 is a diagram showing a display device of the present invention.

FIG. 4 is a functional block diagram of a level shift circuit of the present invention.

FIG. 5 is a diagram showing an embodiment of an output circuit of the level shift circuit of the present invention.

FIG. 6 is a diagram showing related signals of a display driving system of the present invention.

FIG. 7 is a flowchart showing a driving method of the level shift circuit of the present invention.

### DETAILED DESCRIPTION

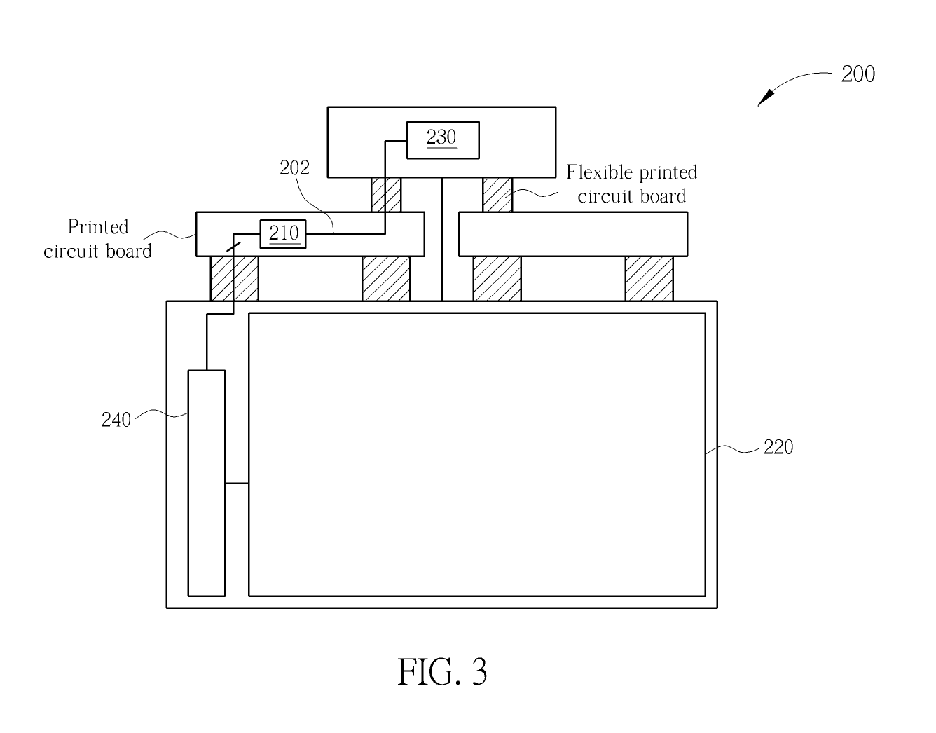

Please refer to FIG. 3. FIG. 3 is a diagram showing a display device 200 of the present invention. As shown in FIG. 3, the display device 200 of the present invention comprises a display module 220, a timing controller 230, a level shift circuit 210, and a gate driving circuit 240. The display module 220 is configured to display images according to image data. The timing controller 230 is configured to generate a coded signal string according to a timing signal for driving the level shift circuit 210. The coded signal string sequentially comprises a starting code, a setting code, a clock standard signal, and an ending code. The level shift circuit 210 is coupled to the timing controller 230 for generating a plurality of clock signals according to the coded signal string of the timing controller 230. The gate driving circuit 240 is coupled between the level shift circuit 210 and the display module 220 for sequentially generating a plurality of scanning signals according to the plurality of clock signals generated by the level shift circuit 210, and outputting the plurality of scanning signals to the display module 220, for driving the display module 220 to display images.

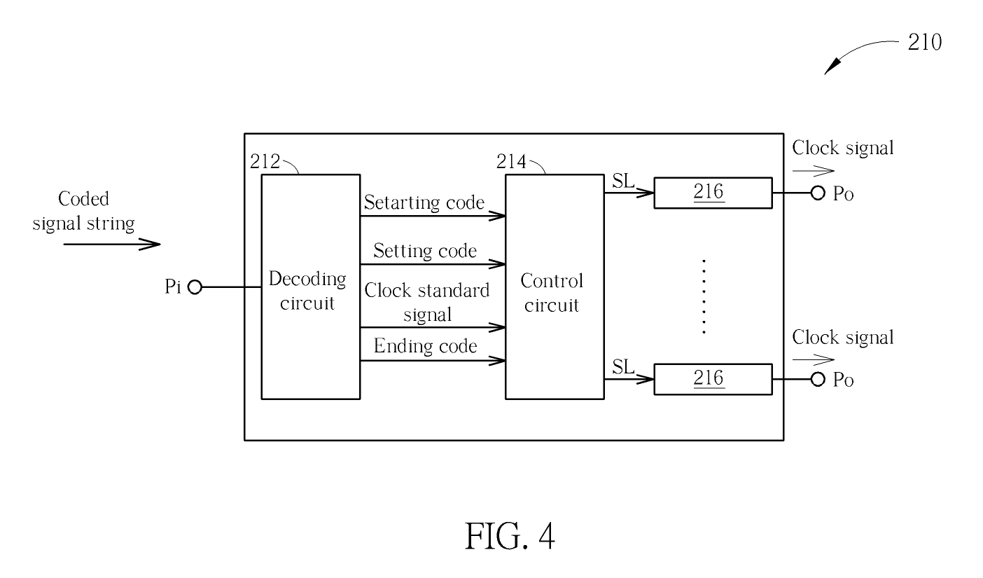

Please refer to FIG. 4, and refer to FIG. 3 as well. FIG. 4 is a functional block diagram of the level shift circuit 210 of the present invention. As shown in FIG. 4, the level shift circuit 210 comprises an input end Pi, a decoding circuit 212, a control circuit 214, and a plurality of output circuits 216. The input end Pi is configured to receive the coded signal string transmitted from the timing controller 230 via a single signal line. The decoding circuit 212 is coupled to the input end Pi for decoding the coded signal string and respectively outputting the starting code, the setting code, the clock standard signal, and the ending code. The control circuit 214 is coupled to the decoding circuit 212 for controlling logic levels of a plurality of logic driving signals SL according to the setting code and the clock standard signal after receiving the starting code, and stopping changing the logic levels of the plurality of logic driving signals SL after receiving the ending code. The plurality of output circuits 216 are coupled to the control circuit 214 for outputting a plurality of clock signals (such as high-frequency clock signals and low-frequency clock signals) according to the corresponding logic driving signals SL.

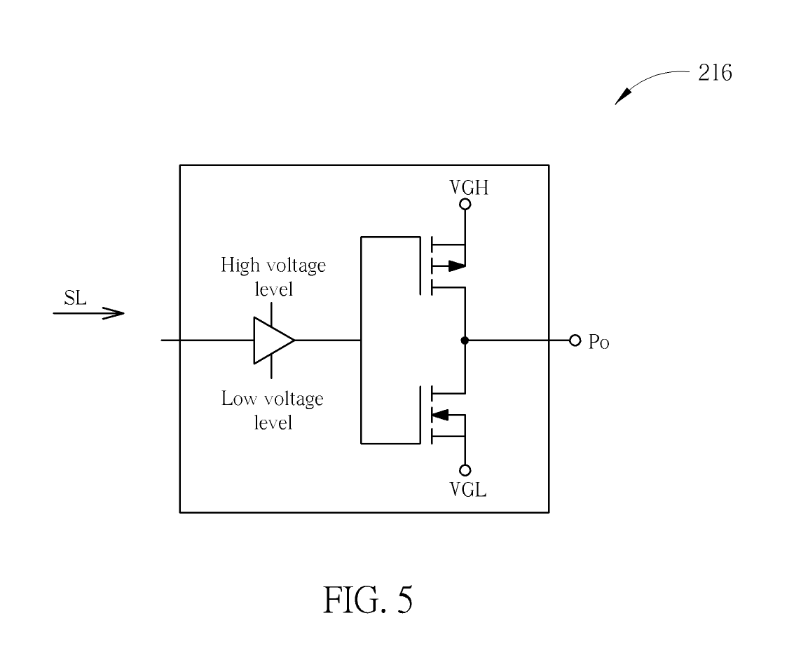

Please refer to FIG. 5, and refer to FIG. 4 as well. FIG. 5 is a diagram showing an embodiment of the output circuit 216 of the level shift circuit of the present invention. As shown in FIG. 5, each output circuit 216 outputs a clock signal between a first voltage level VGH and a second voltage level VGL according to the logic driving signal SL.

According to the above arrangement, a signal transmission interface 202 between the level shift circuit 210 and the timing controller 230 of the present invention requires to arrange only one signal line for transmitting the coded signal string. Since the level shift circuit 210 of the present invention requires no setting end, the signal line of the level shift circuit of the present invention only occupies small space on circuit boards (such as on a printed circuit board and a flexible printed circuit board). The level shift circuit 210 can further generate clock signals required by the gate driving circuit 240 and/or other driving circuits according to the coded signal string.

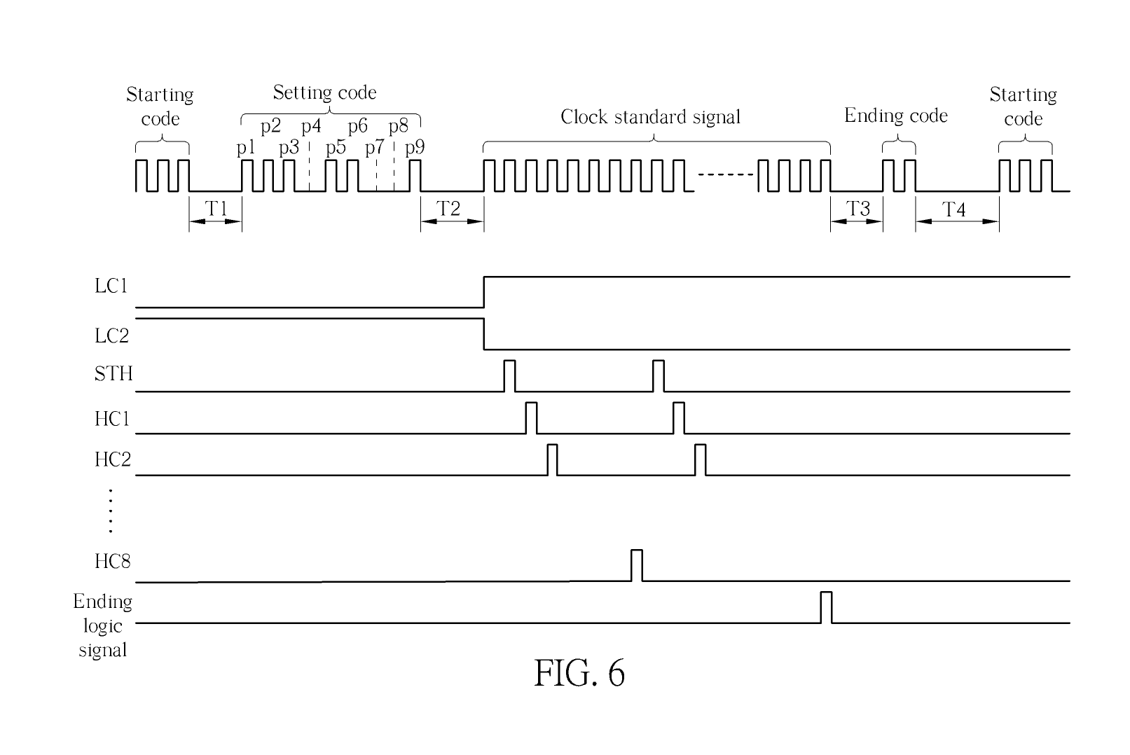

For example, please refer to FIG. 6, and refer to FIG. 3 to FIG. 5 as well . FIG. 6 is a diagram showing related signals of a display driving system of the present invention. As shown in FIG. 6, up most timing diagram is the coded signal string which sequentially comprises a starting code, a setting code, a clock standard signal, and an ending code. Time intervals T1-T4 are arranged behind the starting code, the setting code, the clock standard signal, and the ending code respectively, such that the decoding circuit 212 can respectively decode the coded signal string into the starting code, the setting code, the clock standard signal, and the ending code. When the decoding circuit 212 detects the first time interval T1, it indicates that the starting code has been received, the starting code is further coded from the coded signal string by the decoding circuit 212 and outputted to the control circuit 214 for notifying the control circuit 214 to start operating. When the decoding circuit 212 detects the second time interval T2, it indicates that the setting code has been received, the setting code is further coded from the coded signal string by the decoding circuit 212 and outputted to the control circuit 214. The clock standard signal is arranged between the second time interval T2 and the third time interval T3. When the clock standard signal is coded from the coded signal string by the decoding circuit 212 and outputted to the control circuit 214, the control circuit 214 can respectively control the logic levels of the plurality of logic driving signals SL outputted to the output circuit 216 according to the setting code and the clock standard signal. The output circuits 216 then output different clock signals (such as high-frequency clock signals HC1-HC8 and low-frequency clock signals LC1-LC2) according to the corresponding logic driving signals SL between the second time interval T2 and the third time interval T3. When the decoding circuit 212 detects a fourth time interval T4, it indicates that the ending code has been received, the ending code is further coded from the coded signal string by the decoding circuit 212 and is outputted to the control circuit 214 for notifying the control circuit 214 to stop changing the logic levels of the logic driving signals SL. The level shift circuit 210 repeats the above processes when receiving another starting code again.

In addition, length of the setting code can be equal to length of a plurality of pulses (such as length of 9 pulses in FIG. 6), so as to contain different setting parameters in the setting code. For example, length of the first two pulses P1-P2 can contain setting parameters of phases of the clock signals. Length of the third pulse P3 can contain setting parameters of time intervals of the high-frequency clock signals. Length of the fourth and fifth pulses P4-P5 can contain setting parameters of a charge sharing mode. Length of the sixth pulse P6 can contain setting parameters of a half source driving (HSD) mode. Length of the seventh and eighth pulses P7-P8 can contain pre-charge setting parameters. The setting code can define other setting parameters according to design requirements. Moreover, lengths of the first to fourth time intervals T1-T4 can be different in order to allow the decoding circuit 212 determining contents of the coded signal string.

A format of the coded signal string in FIG. 6 is only an example for illustrating the embodiment of the present invention. The format of the coded signal string of the present invention is not limited to the format of the coded signal string in FIG. 6.

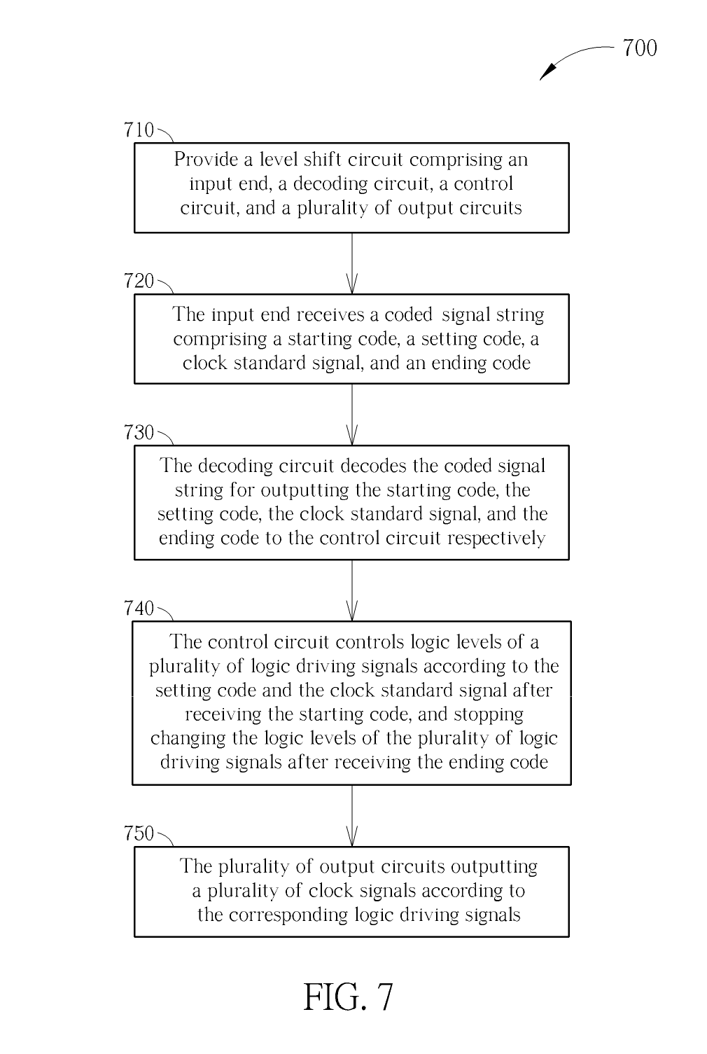

Please refer to FIG. 7. FIG. 7 is a flowchart 700 showing a driving method of the level shift circuit of the present invention. The flowchart of the driving method of the level shift circuit of the present invention comprises the following steps:

Step 710: Provide a level shift circuit comprising an input end, a decoding circuit, a control circuit, and a plurality of output circuits;

Step 720: The input end receives a coded signal string comprising a starting code, a setting code, a clock standard signal, and an ending code;

Step 730: The decoding circuit decodes the coded signal string for outputting the starting code, the setting code, the clock standard signal, and the ending code to the control circuit respectively;

Step 740: The control circuit controls logic levels of a plurality of logic driving signals according to the setting code and the clock standard signal after receiving the starting code, and stopping changing the logic levels of the plurality of logic driving signals after receiving the ending code; and

Step 750: The plurality of output circuits outputting a plurality of clock signals according to the corresponding logic driving signals.

In contrast to the prior art, the level shift circuit of the present invention can receive the coded signal string from the timing controller via one single signal line in order to further generate various types of clock signals required by the driving circuit of the display device. Therefore, the signal line of the level shift circuit of the present invention only occupies small space on circuit boards, so as to reduce difficulties and complexity for circuit layout design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A level shift circuit, comprising:
an input end, configured to receive a coded signal string comprising a starting code, a setting code, a clock standard signal, and an ending code;
a decoding circuit, coupled to the input end for decoding the coded signal string and outputting the starting code, the setting code, the clock standard signal, and the ending code respectively;
a control circuit, coupled to the decoding circuit for controlling logic levels of a plurality of logic driving signals according to the setting code and the clock standard signal after receiving the starting code, and stopping changing the logic levels of the plurality of logic driving signals after receiving the ending code; and
a plurality of output circuits, coupled to the control circuit for outputting a plurality of clock signals according to the corresponding logic driving signals.

2. The level shift circuit of claim 1, wherein time intervals are arranged behind the starting code, the setting code, the clock standard signal, and the ending code respectively.

3. The level shift circuit of claim 1, wherein the coded signal string is generated according to a timing signal of a timing controller.

4. The level shift circuit of claim 1, wherein the plurality of clock signals are different clock signals.

5. A display driving system, comprising:
a timing controller, configured to generate a coded signal string according to a timing signal, the coded signal string comprising a starting code, a setting code, a clock standard signal, and an ending code;
a level shift circuit, comprising:
an input end, configured to receive the coded signal string;
a decoding circuit, coupled to the input end for decoding the coded signal string and outputting the starting code, the setting code, the clock standard signal, and the ending code respectively;
a control circuit, coupled to the decoding circuit for controlling logic levels of a plurality of logic driving signals according to the setting code and the clock standard signal after receiving the starting code, and stopping changing the logic levels of the plurality of logic driving signals after receiving the ending code; and
a plurality of output circuits, coupled to the control circuit for outputting a plurality of clock signals according to the corresponding logic driving signals; and
a gate driving circuit, configured to sequentially generate a plurality of scanning signals according to the plurality of clock signals.

6. The display driving system of claim 5, wherein time intervals are arranged behind the starting code, the setting code, the clock standard signal, and the ending code respectively.

7. The display driving system of claim 5, wherein the plurality of clock signals are different clock signals.

8. A driving method of a level shift circuit, comprising:
providing a level shift circuit comprising an input end, a decoding circuit, a control circuit, and a plurality of output circuits;
the input end receiving a coded signal string comprising a starting code, a setting code, a clock standard signal, and an ending code;
the decoding circuit decoding the coded signal string for respectively outputting the starting code, the setting code, the clock standard signal, and the ending code to the control circuit;
the control circuit controlling logic levels of a plurality of logic driving signals according to the setting code and the clock standard signal after receiving the starting code, and stopping changing the logic levels of the plurality of logic driving signals after receiving the ending code; and
the plurality of output circuits outputting a plurality of clock signals according to the corresponding logic driving signals.

9. The driving method of claim 8, wherein time intervals are arranged behind the starting code, the setting code, the clock standard signal, and the ending code respectively.

10. The driving method of claim 8 further comprising generating the coded signal string according to a timing signal of a timing controller.

11. The driving method of claim 8, wherein the plurality of clock signals are different clock signals.

12. The driving method of claim 8, wherein the plurality of clock signals are outputted to a gate driving circuit, and the gate driving circuit sequentially generates a plurality of scanning signals according to the plurality of clock signals.

13. A display device, comprising:
a display module, configured to display images according to image data;
a timing controller, configured to generate a coded signal string according to a timing signal, the coded signal string comprising a starting code, a setting code, a clock standard signal, and an ending code;
a level shift circuit, comprising:
an input end, configured to receive the coded signal string;
a decoding circuit, coupled to the input end for decoding the coded signal string and outputting the starting code, the setting code, the clock standard signal, and the ending code respectively;
a control circuit, coupled to the decoding circuit for controlling logic levels of a plurality of logic driving signals according to the setting code and the clock standard signal after receiving the starting code, and stopping changing the logic levels of the plurality of logic driving signals after receiving the ending code; and
a plurality of output circuits, coupled to the control circuit for outputting a plurality of clock signals according to the corresponding logic driving signals; and
a gate driving circuit, coupled between the level shift circuit and the display module for sequentially generating a plurality of scanning signals according to the plurality of clock signals, and outputting the plurality of scanning signals to the display module.

14. The display device of claim 13, wherein time intervals are arranged behind the starting code, the setting code, the clock standard signal, and the ending code respectively.

15. The display device of claim 13, wherein the plurality of clock signals are different clock signals.
